(19) United States
(12) Patent Application Publication
(10) Pub. No.: US 2019/0013118 A1
(43) Pub. Date: Jan. 10, 2019

(54) System For Cooling A Cable

(71) Applicant: SAMP S.P.A. CON UNICO SOCIO, Bentivoglio (IT)

(72) Inventors: Antonio Gumina, Bentivoglio (IT); Daniele Balestrino, Bentivoglio (IT)

(73) Assignee: SAMP S.P.A. CON UNICO SOCIO, Bentivoglio (IT)

(21) Appl. No.: 16/063,011

(22) PCT Filed: Dec. 19, 2016
(86) PCT No.: PCT/IB2016/057785

§ 371 Date: Jun. 15, 2018

(30) Foreign Application Priority Data
Dec. 17, 2015 (IT) 102015000084567

(51) Int. Cl. H01B 13/14; B29C 47/00; B29C 47/02; B29C 47/88; B65H 54/22; B65H 67/04; B65H 71/00

(52) U.S. Cl. CPC H01B 13/145; B29C 47/0014; B29C 47/025; B29K 2705/10; B65H 54/22; B65H 67/0405; B65H 71/00; B29C 47/8815

(57) ABSTRACT

A cooling system (100) for cooling a cable (10). The system (100) comprises: —at least one fixed cooling channel (20), which is arranged downstream of an extrusion head (EH); and —at least one multi-pass apparatus (30), which in turn comprises a set of fixed pulleys (32, 33, 34), and a fixed, motor-driven capstan (35) designed to wind the cable (10). The system (100) is characterized in that the multi-pass apparatus (30) comprises a movable pulley (36) designed to translate along vertical guides (39A, 39B). The movable pulley (36) and the vertical guides (39A, 39B) are contained in a cooling device (56) for cooling the cable (10).

### TECHNICAL FIELD

The present invention relates to a system for cooling a cable.

In particular, the present invention finds advantageous, but not exclusive, application in the cooling of an electrical cable, to which the following description will make explicit reference without thereby losing generality.

### BACKGROUND ART

As is known, current systems for the cooling of cables comprise the following devices arranged in series:
at least one fixed cooling channel downstream of the extrusion head; and
a (normally horizontal) multi-pass apparatus comprising a set of fixed pulleys, and a fixed, motor-driven capstan.

In addition, with regard to a traditional system, the cooling length of the cable, as well as the cable accumulation in the multi-pass apparatus, are fixed; moreover, the tensioning of the cable downstream of the multi-pass apparatus is controlled by a sensor device.

However, the current systems, while ultimately ensuring high productivity, have the following drawbacks:
the cooling of the cable is substantially fixed;
the management of the multi-pass apparatus is delegated to a sensor device that does not always guarantee adequate accuracy; and
when the spool must be changed downstream of the cooling system, the line itself must be stopped, with a consequent loss of productivity of the overall system.

### DISCLOSURE OF INVENTION

So, the main object of the present invention is to provide a system for cooling a cable, which is free from the drawbacks described above and, at the same time, is easy and inexpensive to manufacture.

Therefore, in accordance with the present invention, a system for cooling a cable is provided as defined in the attached independent claim, and preferably, in anyone of the claims, directly or indirectly, dependent on said independent claim.

### BRIEF DESCRIPTION OF THE DRAWINGS

For a better understanding of the present invention, a preferred embodiment thereof will now be described, purely by way of non limiting example, with reference to the accompanying drawings, wherein:

FIG. 1 is a three-dimensional illustration of an overall lay-out of a system for cooling a cable according to the teachings of the present invention;

FIG. 2 shows some enlarged details of the lower portion of a multi-pass apparatus used in the cooling system of FIG. 1;

FIG. 3 shows some enlarged details of the upper portion of a multi-pass apparatus used in the cooling system of FIG. 1; and

FIG. 4 shows a rear view of some details of the multi-pass apparatus shown in FIGS. 2, 3.

### BEST MODE FOR CARRYING OUT THE INVENTION

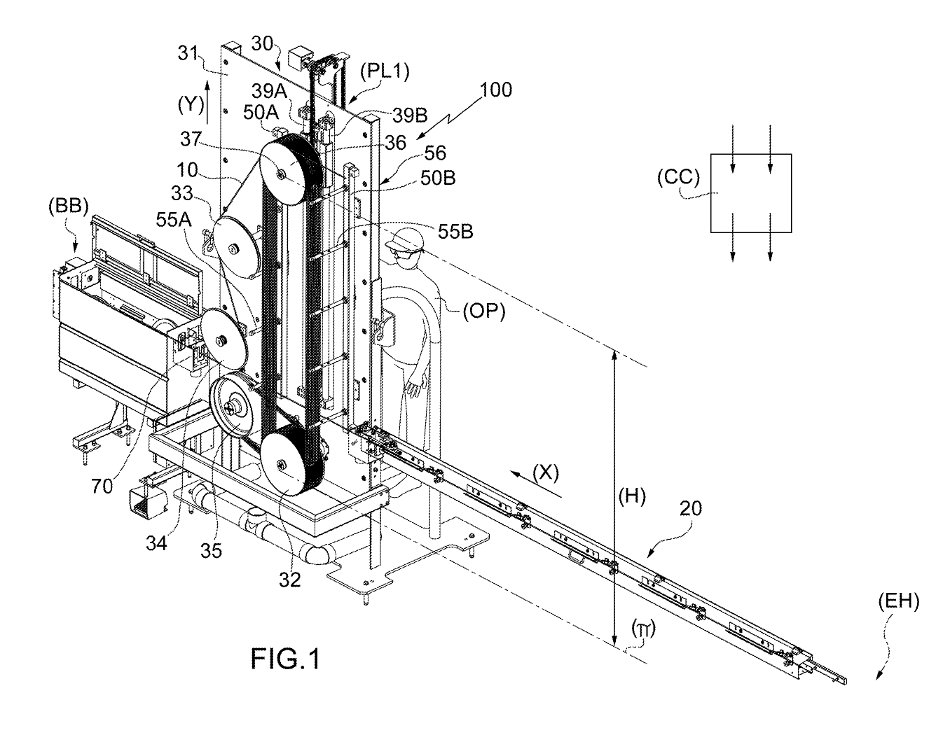

In FIG. 1, the numeral 100 indicates as a whole a system for cooling a cable 10 manufactured according to the specifications of the present invention.

The cooling system 100 for cooling the cable 10 (for example, made of PVC-coated copper) is located between an extrusion head (EH) and a winding machine (BB).

The cooling system 100 further comprises a fixed cooling channel 20 of a known type, which therefore will not be described in detail, and a multi-pass apparatus 30, that, in the embodiment illustrated in the attached figures, extends along a vertical axis with respect to the forward movement direction of the cable 10.

In other words, if the cable 10 in the channel 20 lies substantially along a first horizontal axis (X), the multi-pass apparatus 30, in this specific case, extends along a second vertical axis (Y), perpendicular to the first axis (X).

The multi-pass apparatus 30 comprises a frame 31 which supports three fixed pulleys 32, 33, 34, and a fixed, motor-driven capstan 35.

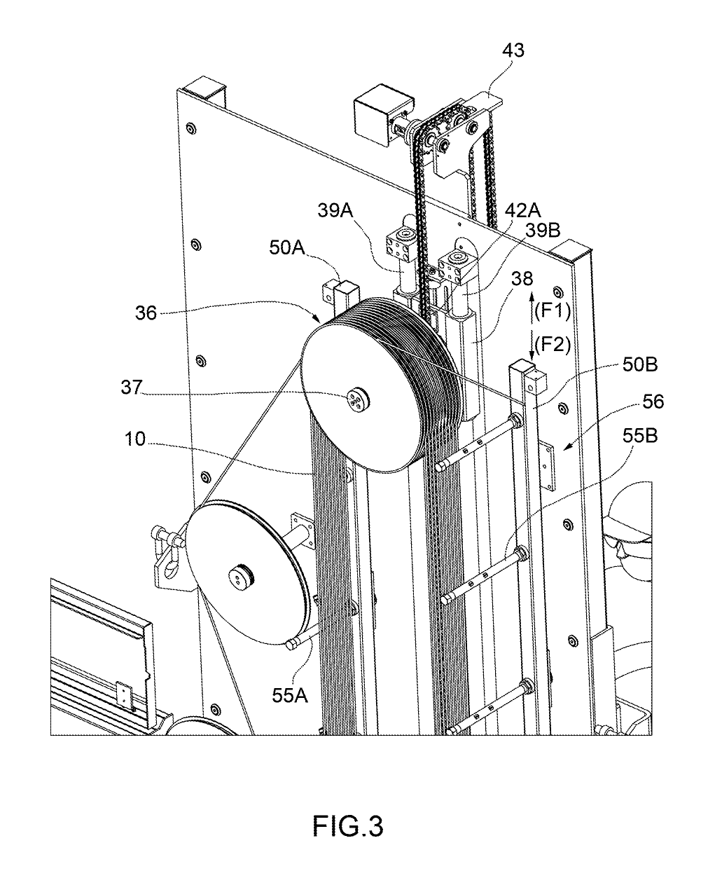

The multi-pass apparatus 30 further includes a movable pulley 36 designed to rotate around a central hub 37 mounted above a respective slide 38 (FIG. 3).

Moreover, it should be noted that while the pulleys 32, 34 and the capstan 35 are located in the lower part of the multi-pass apparatus 30, the pulleys 33, 36 are located in the upper part of the same multi-pass apparatus 30.

As illustrated in greater detail in FIG. 3, the slide 38 is adapted to slide along two fixed vertical guides 39A, 39B.

More precisely, the slide 38 and the movable pulley 36 pivoted thereon can move, as will be seen better later, along the second axis (Y) and two opposite directions defined by two arrows (F1), (F2) (FIG. 3).

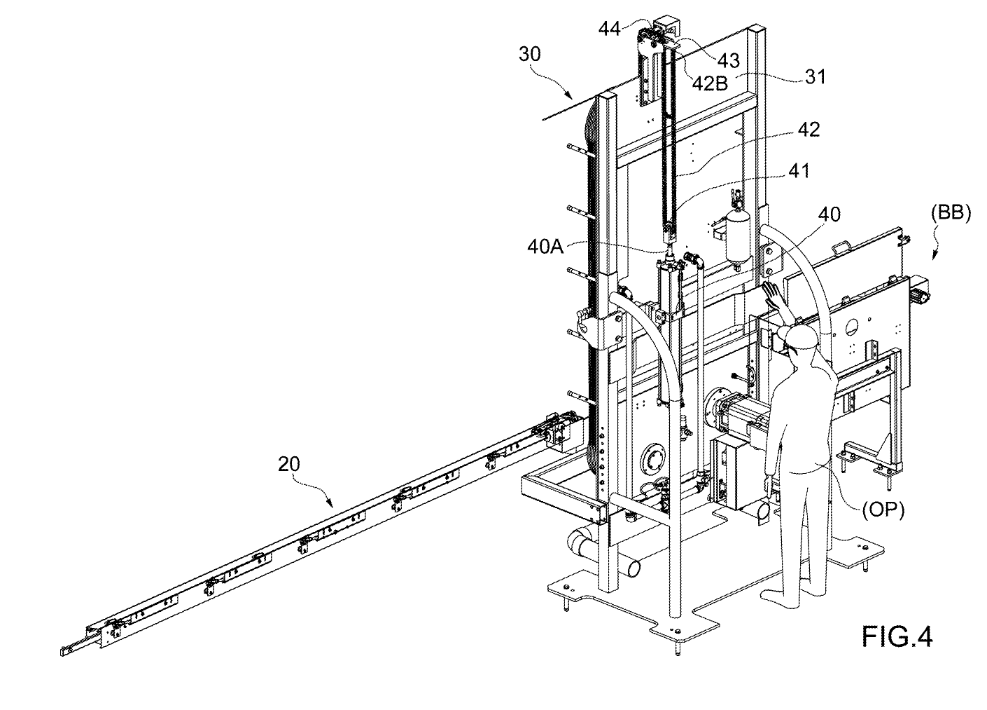

As shown in FIGS. 3, 4, the slide 38 is moved vertically by an (oleodynamic or pneumatic) actuator 40 fastened to the back of the frame 31. The stem 40A of the actuator 40 acts on a spool 41 gripping on a chain 42 (but it could be a smooth or toothed belt or the like).

The actuator 40 also generates the desired pull on the cable 10. The pull or tension on the cable 10 can vary according to the size of the cable 10 and can be set with the aid of a known thrust adjustment system.

Although the accompanying figures show an actuator 40, it is appreciated by the person of skill in the art that any means of implementation (movement) through which the slide 38 can be moved is comparable to said actuator 40.

As again shown in FIGS. 3, 4, a first end 42A of the chain 42 is fastened to the slide 38 (FIG. 3), while a second end 42B is fastened to a bracket 43 projecting towards the rear part of the frame 31.

The bracket 43 also serves as a support for a device 44 guiding the chain 42 towards the slide 38 (FIG. 4).

The chain 42 is also tensioned by the weight of the movable pulley 36 and by the amount of cable 10 wound around it (see below).

Therefore, by shortening or lengthening the stem 40A of the actuator 40, the slide 38 will rise (arrow (F1)) or descend (arrow (F2)), respectively.

As will be seen better later, all operations relating to the present system 100 are set and controlled by an electronic control unit (CC) (FIG. 1) interfaced with an operator (OP) via a keyboard (not shown), or similar device.

FIG. 1 (see also FIG. 3) also illustrates two vertical conduits 50A, 50B that supply cooling water, which is spread by means of nozzles 55A, 55B on the amount of cable 10 arranged in a vertical position and wound between the fixed pulley 32 and the movable pulley 36.

The two vertical conduits 50A, 50B with the respective nozzles 55A, 55B form a water cooling device 56 contained inside the multi-pass apparatus 30.

The water cooling device 56, in turn, contains on the inside the movable pulley 36, the central hub 37, the carriage 38 and the two fixed vertical guides 39A, 39B.

Again from observing FIG. 1, it can be seen that each of the two vertical conduits 50A, 50B that supply cooling water is arranged vertically and laterally with respect to a vertical guide 39A, 39B, respectively.

The water injected inside the multi-pass apparatus 30, after contacting and cooling the cable 10, is collected by gravity in a tank (not shown) located on the bottom of said multi-pass apparatus 30.

From the tank the water is then received in special discharge pipes which can transfer the water by means of an electro-pump (recycling it) to a suitable settling tank (not shown), or transferred by gravity to a well, or to a collection system of the final user.

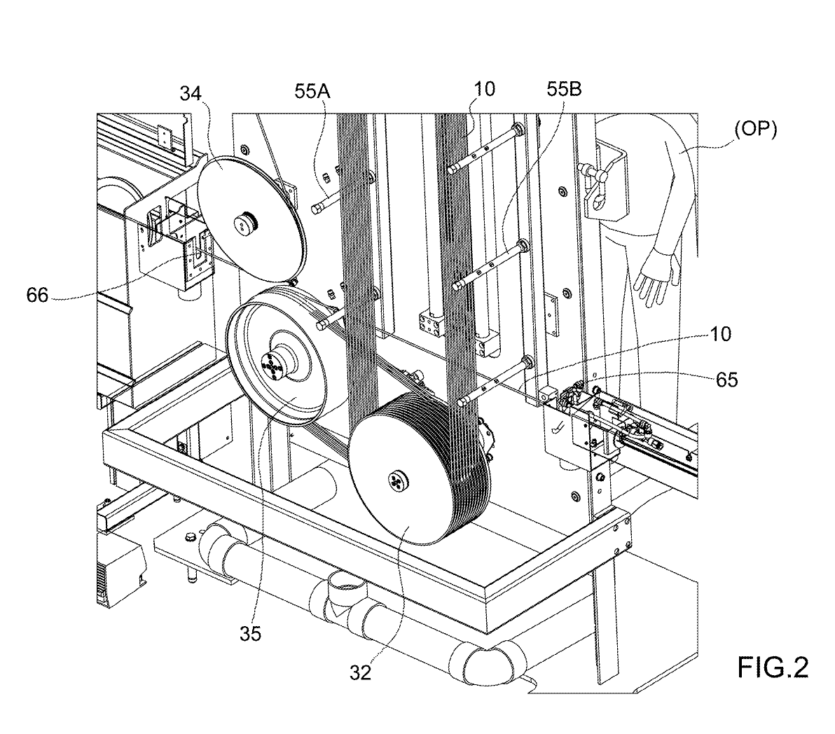

As shown in FIGS. 1-3, the cable 10, after having undergone a first cooling during the passage in the channel 20, enters the multi-pass apparatus 30 through an inlet 65 (FIG. 2).

The cable 10 is pulled by the capstan 35 and diverted towards the fixed pulley 32 (FIG. 2).

The cable 10 is then sent back 4/5 times between the capstan 35 and the fixed pulley 32, and then deflected vertically from the fixed pulley 32 in the direction of the movable pulley 36.

The cable 10 is then sent back at least about ten times between the movable pulley 36 and the fixed pulley 32, and is then deflected from the movable pulley 36 towards the fixed pulley 33 (FIG. 1).

The cable 10 is only partially wound once around the fixed pulley 33, and then it proceeds towards the fixed pulley 34 from which it exits horizontally from an outlet 66 (FIG. 2).

After the outlet 66, there is a cable-lock clamp 70 arranged between the winding machine (BB) and the multi-pass apparatus 30 (FIG. 1).

As will be seen better later when we discuss the operation of the system 100, the movable pulley 36 can move vertically along the two guides 39A, 39B, inside a sort of tunnel formed by two vertical conduits 50A, 50B, due to the effect of the pull on the cable 10 carried out by the capstan 35, and due to the action of the actuator 40 (FIG. 4).

In effective use, therefore, the height (H) (FIG. 1) of the central hub 37 with respect to a reference plane (n) (which passes through the central axis of the fixed pulley 32) can vary by increasing or decreasing the amount of cable 10 wound around the two pulleys 32, 36.

General indications on the operation of the system are given below:
at the beginning, the line is stopped to allow for the threading of the cable 10;
the carriage 38 with the movable pulley 36 is lowered to its initial position in order to make easier the threading of the multi-pass apparatus 30; the movable pulley 36 is then raised by means of the actuator 40 to a default operating position (PL1) or to any other intermediate operating position; at the end of the threading of the line, the clamp 70 is tightened onto the cable 10;
at the line start, the clamp 70 opens up;
therefore, when the line is in operation, the cable 10 is inserted in the multi-pass apparatus 30 and the cable-lock clamp 70 is open;
the capstan 35 rotates at the line speed;
the fixed pulleys 32, 33, 34 rotate;
the movable pulley 36 rotates and the respective carriage 38 is in a generic operating position (PLX) (not shown in the attached figures), which corresponds to a position on the sliding guides 39A, 39B;

in particular, the aforesaid generic operating position (PLX) of the carriage 38 and the pulley 36 (with respect to the minimum and maximum positions) can be changed from 0% to 100%; in other words, the generic operating position (PLX) is a position that fits in an “operating area” (not shown), which is a function of various production parameters;
the movable pulley 36 remains substantially in the generic operating position (PLX), and by moving around this generic operating position (PLX), acts as a sensing device giving feedback to the winder (BB) located downstream of the line; between the clamp 70 and the winder BB, there may be a drying unit for drying the cable 10;
the change from one position to the other allows for the variation of the cooling length of the cable 10 present in the multi-pass apparatus 30, and therefore, ultimately allows for a variation in the amount of cable 10 accumulated in the multi-pass apparatus 30, enhancing the cooling action on the cable 10 itself.

It should also be noted that all operations of movement of the carriage 38 (and therefore of the movable pulley 36) into the multiple operating positions (including the corrections of the tensions on the cable 10) are handled by the actuator 40.

The position of said actuator 40 is constantly controlled by an electronic control unit (not shown) located on the guide device 44, as well as by magnetic sensors (not shown) placed on the actuator 40 itself.

The position of the carriage 38 or of the pulley 36 handled by the actuator 40 is known thanks to the aid of magnetic, inductive, capacitive sensors, or encoders.

Through these sensors or electronic devices it is possible to know the position of the carriage 38 and the cooling length. It is also possible to define the breakage condition of the cable 10 which causes automatic locking of the clamp 70.

If the carriage 38 were to go into a position not suitable to the process (minimum or maximum), a cable 10 breakage condition could be defined, which could stop the line and shut the clamp 70.

In case a spool change on the winder (BB) without line stop is required, the generic operating position (PLX) of the movable pulley 36 is moved to an exchange position;
the winder (BB) stops at the desired line speed;
when the winder (BB) stops, the cable-lock clamp 70 locks itself again around the cable 10 and the movable pulley 36 rises with respect to the plane (n), gathering cable 10 and moving to a new generic operating position (PLX);
after the winder (BB) has started again, the clamp 70 opens up and said winder (BB) starts rotating again at the speed defined by the new temporary generic operating position (PLX) of the movable pulley 36;
the winder (BB) brings the carriage 38 back to the operating position (PL1); the movement of the movable pack around the operating position (PL1) handles the speed of the winder (BB) and, therefore, acts as a sensing device.

The main advantages of the system for cooling a cable which is the object of the present invention are that the multi-pass apparatus acts simultaneously as:
a device for cooling the cable, which is both fixed and variable;
a sensing device for one or more output winders; and
an accumulator (with variable accumulation) for the spool change step without line stop.

Moreover, the whole system also integrates the sensing function for the constant and correct tensioning of the cable and this function, in addition to that of the movement of the movable pulley during the various operating steps, is handled and adjusted by a single actuator located on the back of the frame of the multi-pass apparatus.

1. A cooling system (100) for cooling a cable (10);
the system (100) comprising:
at least one fixed cooling channel (20), which is arranged downstream of an extrusion head (EH); and
at least one multi-pass apparatus (30) comprising a set of fixed pulleys (32, 33, 34) and a fixed, motor-driven capstan (35); said set of fixed pulleys (32, 33, 34) and said capstan (35) being designed to wind said cable (10);
the system (100) being characterized in that said multi-pass apparatus (30) comprises a movable pulley (36), which is designed to translate along guide means (39A, 39B); said movable pulley (36) and said guide means (39A, 39B) being contained in a cooling device (56) for cooling said cable (10).

2. Cooling system (100), according to claim 1, characterized in that said at least one fixed channel (20) lies substantially along a first horizontal axis (X), whereas said at least one multi-pass apparatus (30) extends along a second vertical axis (Y), which is substantially perpendicular to said first horizontal axis (X).

3. Cooling system (100), according to claim 1, characterized in that said cooling device (56) is a water cooling device.

4. Cooling system (100), according to claim 3, characterized in that said cooling device (56) comprises, on the inside, said movable pulley (36), a central hub (37) of said movable pulley (36), a carriage (38), on which said movable pulley (36) and said central hub (37) are mounted, and said two fixed vertical guides (39A, 39B) of said carriage (38).

5. Cooling system (100), according to claim 4, characterized in that said cooling device (56) comprises two vertical conduits (50A, 50B) supplying cooling water; each vertical conduit (50A, 50B) being arranged on the side of a respective vertical guide (39A) and (39B), respectively, of said carriage (38).

6. Cooling system (100), according to claim 5, characterized in that said two vertical conduits (50A, 50B) supplying water comprise nozzles (55A, 55B) spreading cooling water on the amount of cable (10) arranged in a vertical position and wound between the fixed pulley (32) and the movable pulley (36).

7. Cooling system (100), according to claim 1, characterized in that it further comprises a winding machine (BB); a cable-lock clamp (70) being arranged between said multi-pass apparatus (30) and said winding machine (BB).

8. Cooling system (100), according to claim 1, characterized in that the position of the operating means (40) of said movable pulley (36) is controlled by sensor means.

9. Cooling system (100), according to claim 1, characterized in that the position of said pulley (36) is controlled thanks to the aid of magnetic, inductive, capacitive sensors or encoders.

10. Cooling system (100), according to claim 1, characterized in that, if there is a request for a spool change on a winder (BB) without line stop:
the generic operating position (PLX) of said movable pulley (36) is moved to an exchange position;
said winder (BB) stops at the desired line speed;
when the winder (BB) stops, cable-lock means (70) lock themselves again around the cable (10) and said movable pulley (36) gathers cable (10) moving to a new generic operating position (PLX);
after the winder (BB) has started again, the cable-lock means (70) open up and said winder (BB) starts rotating again at the speed defined by the new temporary generic operating position (PLX) of said movable pulley (36);
the winder (BB) brings said movable pulley (36) back to the operating position (PL1); the movement of the movable pack around the operating position (PL1) handles the speed of the winder (BB) and, therefore, acts as a sensing device.
